(19) United States
(12) Patent Application Publication
(10) Pub. No.: US 2022/0216917 A1
(43) Pub. Date: Jul. 7, 2022

(54) LIGHT COMMUNICATION METHOD AND PROCESS FOR THE SELF-ADAPTIVE RECEPTION OF A LIGHT COMMUNICATION SIGNAL

(71) Applicant: ELLIPZ SMART SOLUTIONS EUROPE, Paris (FR)

(72) Inventors: Green Ojeda Jacob EMIR, San José Del Cabo, Baja California Sur (MX); Perez Olivas Huetzin AARON, Covina, CA (US); Suat TOPSU, VERSAILLES (FR); Jean-Baptiste SEILLIERE, CHAMBESY (CH); Johannes Otto ROOYMANS, OSS (NL)

(21) Appl. No.: 17/609,104

(22) PCT Filed: May 5, 2020
(86) PCT No.: PCT/FR2020/000161

§ 371 Date: Nov. 5, 2021

(30) Foreign Application Priority Data
May 5, 2019 (FR) 1904700

(51) Int. Cl. H04B 10/116

(52) U.S. Cl. CPC H04B 10/116

(57) ABSTRACT

The invention relates to a light communication method (10) implemented by a light communication emitter system (61), in which a reference sequence (320) is shrewdly inserted periodically and repeatedly into a digital data frame to be transmitted by way of a modulated light beam (615). The presence of this reference sequence (320) allows a light communication receiver system (62) to automatically detect the reference sequence (320) in the detected modulated light beam (615). This detection makes it possible to automatically detect one of the two oscillating frequencies used to represent a logic state of the transmitted digital data, without having to calibrate the receiver system (62) on the basis of said oscillating frequencies.

### TECHNICAL FIELD

The technical context of the present invention is that of communication by means of light in order to transport digital data by means of a modulated light beam. More particularly, the invention relates to a light communication method which carries a set of digital data, and to a self-adaptive process for receiving a light signal generated by a light communication method of this kind. The invention also relates to a light communication system for implementing such a method and/or such a process.

### PRIOR ART

In the prior art, systems for communication by means of light are known, such as those which implement LiFi (light fidelity) technology which allows digital data to be transmitted wirelessly by modulating the light emitted by LED (light-emitting diode) lighting. LiFi technology is described in particular in the international standard IEEE802.15.

A known use of this technology is related to the development of indoor geolocation services in order to be able to locate a LiFi receiver in a network of LiFi emitters formed by a similar number of LED lighting devices. In a use of this kind, each LED lighting device is designed to emit a sequence of light signals which carry predetermined geolocation information. In other words, the sequence of light signals corresponds to an optical transposition of a digital signal which groups together binary data. In a known manner, a LiFi receiving module is designed to receive the sequence of light signals and to derive therefrom the geolocation information emitted by the LED lighting device.

The use of a LiFi geolocation system of this kind is known in museums, hospitals or supermarkets in order to send geolocation information to a specific portable terminal and to facilitate interactions between users and the place in which the geolocation system is deployed. By way of non-limiting example, the specific terminal can take the form of an audio guide or a tablet specifically developed for this use since it must comprise a LiFi reception module for detecting the light signal in order to be able to decode the geolocation information transported by said light signal.

Systems of this kind for communication by means of light are costly to develop and integrate because it is necessary both to deploy a network of lighting devices and to make a specific terminal available to users.

It is also known to use cell phones to detect a modulated light signal carrying encoded information, in particular by means of a camera of the cell phone. However, the bandwidth of such a camera makes using said camera compatible with light communication only for low data rates. In addition, the prototypes currently being developed are still unreliable and do not make it possible to receive a constant flow of data without losses.

One aim of the invention is to propose a new light communication method and a new self-adaptive process for receiving a light signal generated by a light communication method of this kind in order to at least predominantly respond to the problems set out above and also lead to further advantages.

Another aim of the invention is to facilitate the generation and detection of a light communication signal by improving its reliability and by reducing the number of bits lost during light communication of this kind.

Another aim of the invention is to make it possible to use a cell phone camera to decode an optical light signal carrying information.

### DISCLOSURE OF THE INVENTION

According to a first aspect of the invention, at least one of the aforementioned aims is achieved by means of a method for communicating digital data by means of light, the light communication method comprising: (i) a receiving step in which a processing unit of a light communication emitter system receives raw digital data; (ii) an insertion step in which the processing unit of the light communication emitter system inserts a reference sequence at a constant interval, referred to as the self-adaptation interval, into the raw digital data, thus forming digital data to be encoded; (iii) a step of encoding the digital data to be encoded according to an encoding protocol implemented by the processing unit of the light communication emitter system, thus forming an encoded digital signal, the encoded digital signal comprising a plurality of digital data divided into at least two different logic states; and (iv) a step of controlling a light source of the light communication emitter system using the encoded digital signal in order to generate a modulated light beam, the intensity of which is modulated by the encoded digital signal.

Thus, the light communication method according to the first aspect of the invention makes it possible to place the reference sequence, which will subsequently facilitate the decoding of the modulated light beam, in the raw digital data to be transmitted. Indeed, the repeated and preferably periodic or quasi-periodic presence of the reference sequence in the modulated light beam makes it possible to implement a self-adaptive receiving process which automatically detects the reference sequence in order to initiate the decoding of the modulated light beam. This configuration advantageously facilitates the decoding of such a modulated light beam, thus avoiding the need to specifically parameterize a receiver system on the basis of the parameters of an emitter system that are used to encode the modulated light beam. In addition, this configuration also makes it possible to improve the reliability of transmitting digital data via the modulated light beam.

The light communication method according to the first aspect of the invention advantageously comprises at least one of the developments below, it being possible to implement the technical features forming these developments alone or in combination:
the control step comprises a step of modulating (i) a first logic state of the encoded digital signal according to a first oscillating frequency of the light beam, and (ii) a second logic state of the encoded digital signal according to a second oscillating frequency of the light beam, the second oscillating frequency being different from the first oscillating frequency. Thus, according to this advantageous configuration of the step of controlling the light source, the digital data are transcribed into a plurality of oscillating frequencies specific to the variation in light intensity of the light beam: a first logic state of the digital data, for example equal to 1, is associated with the first oscillating frequency of the light intensity of the light beam, and a second logic state of the digital data, for example equal to 0, is associated with the second oscillating frequency of the light intensity of the light beam. It is therefore the temporal variation of the light intensity of the light beam between its two states that makes it possible to transcribe the logic states of the transported digital data;
a value of the second oscillating frequency is different from a value of the second oscillating frequency by at least 30%. In other words, the first oscillating frequency is different from the second oscillating frequency, and the first oscillating frequency is greater than the second oscillating frequency by at least 30% of the value of the second oscillating frequency; or the first oscillating frequency is different from the second oscillating frequency, and the first oscillating frequency is smaller than the second oscillating frequency by at least 30% of the value of the second oscillating frequency. According to a first preferred variant of the invention according to its first aspect, a value of the second oscillating frequency is between 30% and 60% of a value of the second oscillating frequency. According to a second preferred variant of the invention according to its first aspect, a value of the second oscillating frequency is equal to half of a value of the second oscillating frequency;
advantageously, a difference between the second oscillating frequency and the first oscillating frequency is between 5% and 15% of a bandwidth of a sliding shutter of a photodetector intended to detect the light beam generated by the light communication method according to the first aspect of the invention;
the digital data to be encoded that are edited by the processing unit comprise a header section and a data section, a length of the self-adaptation interval being less than a length of the header section. The header section is used to locate the start of a digital data set, and the data section contains information to be transmitted, such as a geolocation identifier. By way of non-limiting example, the header section is formed of 10 consecutive bits, and/or the data section is formed of at least 16 consecutive bits. Advantageously, the header section having a length N+2 is formed of a sequence of N consecutive bits in a given first logic state, said sequence of N bits being framed at each end by a bit in a second logic state different from the first logic state. Thus, for a 10-bit header section, the first bit of the header section is for example equal to 0, then the following 8 consecutive bits are all equal to 1, and then the tenth bit of the header section is equal to 0. The bits in the data section have logic states which depend on the information they represent. In this advantageous configuration of the light communication method according to the first aspect of the invention, the self-adaptation interval is less than the length of the header section in order to be able to guarantee that the sequence of N consecutive bits in a first logic state formed in the header section is not found in this form in the data section. In other words, the reference bits inserted periodically into the frame of the digital data, in the data section, make it possible to guarantee that there is no sequence of N consecutive bits all in the same logic state in said data section, analogously to the header sequence. This advantageous configuration facilitates the shaping of the light beam by producing a unique identifier which represents a transmission start;
the length of the self-adaptation interval is between one third and two thirds of the length of the header section. The length of the self-adaptation interval is preferably equal to half the length of the header section;
according to another advantageous variant of the invention, the reference sequence is inserted into the data section whenever said data section comprises a sequence of N adjacent bits identical to a portion of N adjacent bits of the header section, the reference sequence being inserted at the end of said sequence of N adjacent bits of the data section. However, if the data section comprises a sequence of N bits which differs from any sequences of N adjacent bits of the header section, in this case the reference sequence is not inserted into the data section;
according to a first variant, the reference sequence comprises exactly one reference bit in a given logic state. The given logic state of the reference bit is preferably equal to 0; it is optionally equal to 1. According to a second variant, the reference sequence takes the form of a checksum of the N directly adjacent preceding bits, N advantageously being equal to approximately half the length of the header section.

According to a second aspect of the invention, a light communication emitter system is proposed, comprising means designed to implement the light communication method according to the first aspect of the invention or according to any of its developments.

An emitter system of this kind thus makes it possible to shape a modulated light beam carrying digital data, in which light beam the digital data are represented by (i) a first oscillating frequency of a light intensity of the modulated light beam for a first logic state of said digital data and (i) a second oscillating frequency of the modulated light beam for a second logic state of said digital data. As mentioned previously, this frequency coding of the digital data makes it possible to improve the reliability of the method for communication by means of light and to make it compatible with a wide variety of photoreceptors, including generic photoreceptors usually found in cameras of consumer electronics such as cell phones, computers or digital tablets.

In particular, the light communication emitter system according to the second aspect of the invention comprises: (i) at least one light source designed to be able to generate a modulated light beam which forms a signal for communication by means of light; (ii) a control module designed to control the at least one light source by generating a control signal from an encoded digital signal; and (iii) a processing unit designed to be able to encode the digital signal to encode by means of digital calculations and/or digital processing and/or logic operations on digital data to be encoded.

As mentioned above, the at least one light source is advantageously a light-emitting diode or a micro-LED. At least some of the light sources are designed to be able to generate a light beam having a wavelength between 350 nm and 800 nm.

The control module advantageously comprises a digital-to-analog converter in order to generate the control signal for polarizing the at least one light source according to the encoded digital signal that it receives. The control module is thus located in an intermediate position between the at least one light source and the processing unit.

By way of non-limiting example, the processing unit advantageously comprises a microprocessor and/or a microcontroller and/or at least one temporary or permanent memory as used in the information technology field.

According to a third aspect of the invention, a self-adaptive process is proposed for receiving a modulated light beam shaped by the light communication method according to the first aspect of the invention or according to any of its developments, the receiving method being implemented by a light communication receiver system and comprising: (i) a step of acquiring the modulated light beam by means of a surface photodetector; (ii) a step of converting the modulated light beam detected by the surface photodetector into a raw digital signal which represents a variation in light intensity of the modulated light beam detected on the surface of said surface photodetector, the conversion step being performed by an analog-to-digital converter of the light communication receiver system; (iii) a step of detecting, in the raw digital signal, a periodic presence of a first oscillating frequency that corresponds to the reference bits of the reference sequence, the detection step being carried out by a processing unit of the light communication receiver system; and (iv) a step of binarizing the raw digital signal by assigning a first logic state to the first detected oscillating frequencies and/or a second logic state to the second detected oscillating frequencies, the step of binarization being carried out by a processing unit of the light communication receiver system.

Thus, the self-adaptive receiving process according to the third aspect of the invention makes it possible to utilize particular editing of the raw digital data in order to facilitate its interpretation by a receiver system and, ultimately, to reduce the risks of data loss during the process of communication by means of light. In other words, this configuration advantageously facilitates the decoding of a modulated light beam, thus avoiding the need to specifically parameterize the receiver system on the basis of the parameters of an emitter system that are used to encode the modulated light beam.

The self-adaptive receiving process according to the third aspect of the invention advantageously comprises at least one of the developments below, it being possible to implement the technical features forming these developments alone or in combination:
the detection step is carried out by a fast Fourier transform method or by an autocorrelation method or by narrow band filtering;
during the binarization step of the self-adaptive receiving process according to the invention according to its third aspect, each portion of the raw digital signal, corresponding substantially to a period taken for example between two successive extremes of said raw digital signal, is associated with a logic state, for example 0 or 1, depending on the frequency which is detected on said corresponding portion of the raw digital signal. Thus, if, for a given portion of the raw digital signal, the detected frequency is equal to the first oscillating frequency to within plus or minus 10%, the corresponding portion of the raw digital signal is forced into a first logic state, for example 1. Similarly, if, for another given portion of the raw digital signal, the detected frequency is equal to the second oscillating frequency to within plus or minus 10%, the corresponding portion of the raw digital signal is forced into a second logic state, for example 0.

According to a fourth aspect of the invention, a light communication receiver system is proposed, comprising means designed to implement the self-adaptive receiving process according to the third aspect of the invention or according to any of its developments.

A receiver system of this kind thus makes it possible to use a photodetector to decode a light communication signal carrying digital data, in which light communication signal the digital data are represented by a first oscillating frequency of the light signal for a first logic value of said digital data and by a second oscillating frequency of the light signal for a second logic value of said digital data. This frequency coding of the digital data makes it possible to improve the reliability of the process for communication by means of light and to make said process compatible with a wide variety of photoreceptors, including generic photoreceptors usually found in cameras of consumer electronics such as cell phones, computers or digital tablets.

In particular, the light communication receiver system according to the fourth aspect of the invention comprises: (i) a photodetector designed to be able to detect a modulated light beam which forms a signal for communication by means of light; (ii) an analog-to-digital converter designed to convert the light communication signal detected by the photodetector into a digital signal which represents the different levels of intensity of said light communication signal; and (iii) a processing unit designed to perform digital calculations and/or digital processing and/or logic operations on the digital signal.

In a non-limiting manner, the photodetector of the light communication receiver system according to the fourth aspect of the invention is advantageously the camera of a cell phone or of a digital tablet or of a portable computer. By way of non-limiting example, the photodetector can be in the form of a CMOS (complementary metal oxide semiconductor) sensor or a CCD (charged coupled device) camera.

More generally, the light communication receiver system according to the fourth aspect of the invention is integrated into a cell phone or a portable computer or a digital tablet, thus allowing its user to receive a light communication signal carrying digital data, for example a geolocation identifier.

By way of non-limiting example, the processing unit advantageously comprises a microprocessor and/or a microcontroller.

According to a fifth aspect of the invention, a system for communication by means of light is proposed, comprising: (i) a light communication emitter system according to the second aspect of the invention or according to any of its developments; and (ii) a light communication receiver system according to the fourth aspect of the invention or according to any of its developments.

In particular, the system for communication by means of light according to the fifth aspect of the invention comprises:
a light communication emitter system comprising: (i) at least one light source designed to be able to generate a modulated light beam which forms a signal for communication by means of light, (ii) a control module designed to control the at least one light source by generating a control signal from an encoded digital signal; and (iii) a processing unit designed to be able to encode the digital signal to encode by means of digital calculations and/or digital processing and/or logic operations on data digital to be encoded; and/or
a light communication receiver system comprising: (i) a photodetector designed to be able to detect a modulated light beam which forms a signal for communication by means of light; (ii) an analog-to-digital converter designed to convert the light communication signal detected by the photodetector into a digital signal which represents the different levels of intensity of said light communication signal; and (iii) a processing unit designed to perform digital calculations and/or digital processing.

Various embodiments of the invention are provided, incorporating the various optional features set out herein in all of their possible combinations.

### DESCRIPTION OF THE FIGURES

Other features and advantages of the invention will become apparent from the following description, and from a number of non-limiting embodiments given by way of example with reference to the appended schematic drawings, in which:

FIG. 1 is a synoptic view of the light communication method according to the first aspect of the invention;

FIG. 2 is a symbolic view of the raw digital data to which the light communication method according to the first aspect of the invention is applied;

FIG. 3 is a symbolic view of the digital data to be encoded as edited by the light communication method according to the first aspect of the invention;

FIG. 4 is a synoptic view of the self-adaptive receiving process according to the third aspect of the invention;

FIG. 5 shows a step of the self-adaptive receiving process according to the third aspect of the invention, in which an example of reconstructing the digital data from the detected light beam is described;

FIG. 6 is a schematic view of a system for communication by means of light according to the fifth aspect of the invention.

Of course, the features, variants and different embodiments of the invention may be combined with one another, in various combinations, insofar as they are not incompatible or mutually exclusive. In particular, it is possible to conceive of variants of the invention which comprise only a selection of features described below in isolation from the other features described, if this selection of features is sufficient to confer a technical advantage or to differentiate the invention from the prior art.

In particular, all of the variants and all of the embodiments described can be combined with one another if there is nothing to prevent this combination from a technical point of view.

In the figures, the elements common to several figures are provided with the same reference sign.

### DETAILED DESCRIPTION OF THE INVENTION

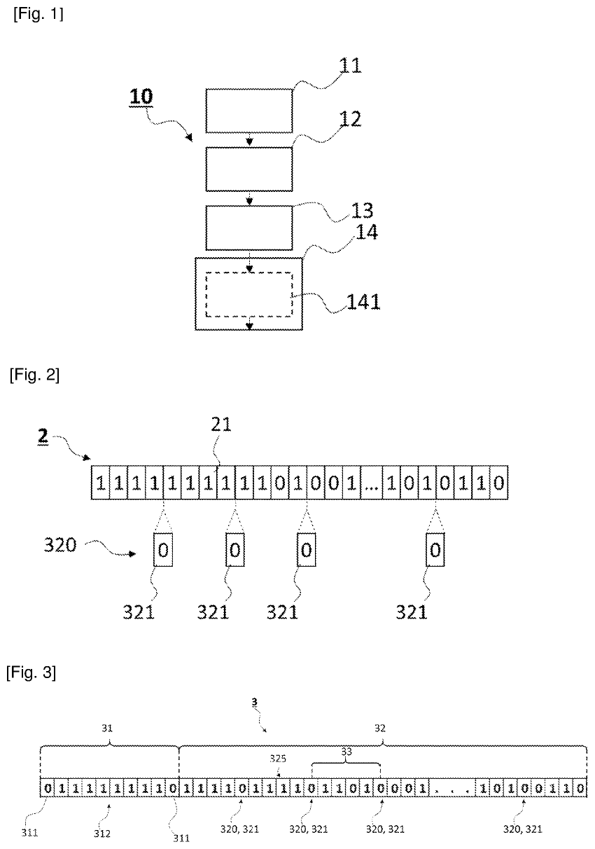

With reference to FIG. 1, the light communication method 10 according to the first aspect of the invention comprises at least one iteration of the following steps:
a receiving step 11 in which a processing unit of a light communication emitter system receives raw digital data;
an insertion step 12 in which the processing unit of the light communication emitter system inserts a reference sequence 320 at a constant interval, referred to as the self-adaptation interval, into the raw digital data 2, thus forming digital data to be encoded 3;
a step 13 of encoding the digital data to be encoded 3 according to an encoding protocol implemented by the processing unit of the light communication emitter system, thus forming an encoded digital signal, the encoded digital signal comprising a plurality of digital data divided into at least two different logic states;
a step 14 of controlling a light source of the light communication emitter system using the encoded digital signal in order to generate a modulated light beam, the intensity of which is modulated by the encoded digital signal.

The step 12 of inserting the reference sequence 320 into the raw digital data 2 is described in more detail with reference to FIGS. 2 and 3.

The raw digital data 2 to which the light communication method 10 according to the first aspect of the invention is applied are shown in FIG. 2: said data are formed by a set of bits which represent information to be transmitted by the modulated light beam. During the insertion step 12, the reference sequence 320 is inserted into the set of bits 21 forming the raw digital data 2. In the example shown in FIGS. 2 and 3, the reference sequence 320 is formed by a single reference bit 321. The set formed by the raw digital data 21 into which the reference sequence 320 is inserted constitutes the digital data to be encoded 3 that can be seen in FIG. 3.

FIG. 3 shows an embodiment of the digital data to be encoded 3. The digital data to be encoded 3 comprise:
a header section 31 in order to locate the start of the data section 32. The header section 31 is formed of N+2 consecutive bits where N is advantageously an integer greater than or equal to 8. In the example shown in FIG. 3, the header section 31 is 10 bits long;
a data section 32 comprising a plurality of bits formed by the raw digital data 2 and the reference sequence 320. By way of non-limiting example, the data section can form a geolocation identifier.

As can be seen in FIG. 3, the header section comprises a sequence of N consecutive bits 312 in a given first logic state, for example equal to 1 in the example shown in FIG. 3. More generally, the N consecutive bits 312 of the header section 31 all have the same first logic state.

At each end of the sequence of N consecutive bits 312, the header section 31 comprises a terminal bit 311. Each terminal bit has a second logic state different from the first logic state of the N consecutive bits 312. In other words, if the N consecutive bits 312 are in the strong logic state equal to 1, the terminal bits 311 are equal to 0.

In the example shown in FIGS. 2 and 3, the header section 31 comprises 10 bits:
the first bit of the header section 31 forms the first terminal bit 311 and is equal to 0;
the following 8 consecutive bits 312 are all equal to 1;
the tenth bit of the header section 31 forms the last terminal bit 31 and is equal to 0.

The role of the header section 31 is to form an original sequence with respect to the data section 32 in order to be able to very clearly identify the header sequence in a frame of data transmitted by a system for emitting the modulated light beam. In other words, the header section 31 thus formed by the light communication method 10 according to the first aspect of the invention is defined such that it cannot be found in this form in the data section 32.

The bits of the data section 32 have logic states which depend on the information they represent. In order to guarantee not to find a sequence of bits corresponding exactly to the header section 31 in the data section 32, the data section 32 comprises a plurality of reference sequences 320, each occurrence of the reference sequence being separated from the immediately following occurrence by the self-adaptation interval 33. In other words, two directly consecutive reference sequences 320 are separated by X bits, with the number X forming the self-adaptation interval 33.

The insertion step 12 of the light communication method 10 cleverly defines a length of the self-adaptation interval 33 such that it is less than the length of the header section 31. The length of the self-adaptation interval 33 is preferably equal to half of N, with N being the number of consecutive bits 312 in the header section 31. This clever configuration in fact makes it possible to guarantee that the sequence of N consecutive bits 312 of the header section 31 is not found in this form in the data section 32. In the example shown in FIGS. 2 and 3, the reference sequence 33 is formed by exactly one low-order bit, i.e. equal to 0; and the self-adaptation interval is equal to 4 bits: the light communication method 10 according to the first aspect of the invention, during the insertion step 12, inserts a reference bit 321 equal to 0 every 4 bits of raw digital data 2.

According to another variant not shown in FIG. 3, the reference sequence could be introduced into the data section 32 whenever, and only if, there is a sequence of X successive bits of the data section 31 identical to a sequence of X successive bits of the header section, X being equal to the self-adaptation interval.

During the encoding step 13, the light communication method 10 according to the first aspect of the invention transforms the digital data to be encoded 3 into a digital signal encoded by means of an encoding protocol. This transformation of the digital data to be encoded 3 can comprise in particular an On-Off Keying or Manchester transformation, for example.

The step 14 of controlling the light source optionally comprises a step 141 of modulating (i) a first logic state of the encoded digital signal according to a first oscillating frequency of the light beam, and (ii) a second logic state of the encoded digital signal according to a second oscillating frequency of the light beam, the second oscillating frequency being different from the first oscillating frequency.

Thus, each logic state of the encoded digital signal carried by the modulated light beam is associated with a particular oscillating frequency: the high-order bits equal to 1 are represented by a variation in intensity of the light beam according to a first oscillating frequency, while the low-order bits equal to 0 are represented by a variation in intensity of the light beam according to a second oscillating frequency. For the proper functioning of the light communication method according to the first aspect of the invention, the selected oscillating frequencies should be sufficiently different from one another. By way of non-limiting example, it is possible to select a first oscillating frequency that is different from the second oscillating frequency by at least 30%, or even a first oscillating frequency equal to half of the second oscillating frequency.

For better pairing between the light source of a light communication emitter system and a light communication receiver system, it is preferable to define the oscillating frequencies of the modulated light signal in such a way that the first oscillating frequency of the modulated light beam generated by the light source of the light communication emitter system is detected by a number of lines of light-sensitive cells of the light communication receiver system that is greater by at least 4 than the number of lines of light-sensitive cells of said light communication receiver system detecting the second oscillating frequency of the modulated light beam.

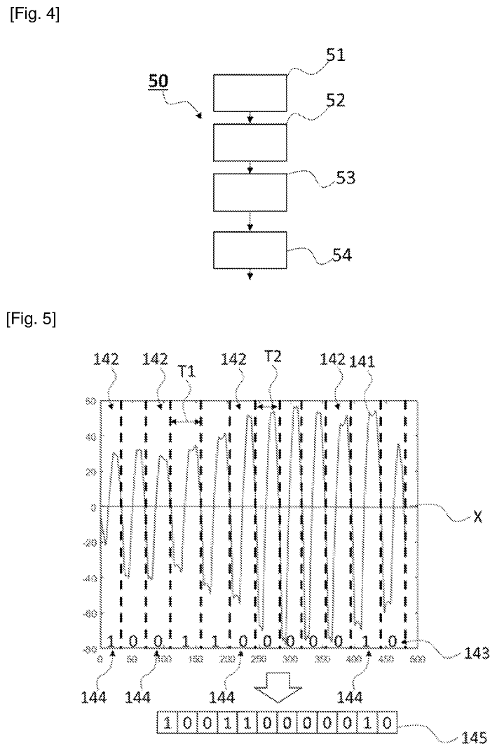

FIG. 4 shows a self-adaptive process 50 for receiving a modulated light beam shaped by the light communication method 10 as described above. The receiving process 50 comprises:
a step 51 of acquiring the modulated light beam;
a step 52 of converting the detected modulated light beam into a raw digital signal which represents a variation in light intensity of the detected modulated light beam;
a step 53 of detecting, in the raw digital signal, a periodic presence of a first oscillating frequency that corresponds to the reference bits 321 of the reference sequence 320;
a step 54 of binarizing the raw digital signal by assigning a first logic state to the first detected oscillating frequencies and/or a second logic state to the second detected oscillating frequencies.

The acquisition step 51 and conversion step 52 together produce the raw digital signal from a detected optical signal, the modulated light beam, in an electronic transposition. This step is most particularly implemented by a photodetector, as will be described later with reference to FIG. 5.

The detection step 53 consists in locating, in the raw digital signal, the presence of the reference sequence 320 which has been inserted into the data frame to be transmitted by the light communication method 10 as described above. The fact that the reference sequence 320 has been inserted into the raw digital data 2 in a recurrent and periodic manner cleverly facilitates this detection, in particular by implementing a fast Fourier transform method, for example. Indeed, the expected, repeated and for example periodic or quasi-periodic presence of the reference bit 321 at a constant interval makes it possible, in the self-adaptive receiving process 50, to automatically calibrate one of the two oscillating frequencies used to represent a logic state of the bits of the data frame. In other words, as one of the logic states is represented by an oscillating frequency and said logic state represented in this way is placed periodically and repeatedly following the self-adaptation interval 33, the detection step thus makes it possible to easily and quickly find this repetition and, ultimately, identify the oscillating frequency which is used to represent the logic state of the reference bit 321.

This simple detection thus eliminates the need to parameterize the light communication receiver system with the value of the oscillating frequencies used by the light communication emitter system. One of the two values is determined during the detection step 53 by finding the reference sequence 320 in the raw digital signal. The other oscillating frequency is derived from the first, as are for example all of the other frequencies which are not equal or are sufficiently different from the first oscillating frequency detected in this way. Alternatively, the other oscillating frequency is not determined from the first oscillating frequency determined during the detection step 53.

Once the first oscillating frequency has been detected and/or the second oscillating frequency has been derived, the self-adaptive receiving process 50 implements the binarization step 54 in order to reconstruct a data frame as it had been transmitted by the light communication emitter system.

The binarization step 54 is shown in more detail in FIG. 5. During the binarization step 54, the raw digital signal 141 is analyzed in order to identify the different occurrences of the first and second oscillating, each portion of the raw digital signal 141, corresponding substantially to a period taken for example between two successive extremes of said raw digital signal, is associated with a logic state, for example 0 or 1, depending on the frequency which is detected on said corresponding portion of the raw digital signal 141. By way of non-limiting example, a step of determining the period or pseudo-period can be carried out on each portion 142 of the raw digital signal 141 taken between two falling edges of the raw digital signal 141 on the origin axis X. These portions 142 are identified in FIG. 5 by vertical dotted lines.

A period or pseudo-period measurement on each of these portions 142 makes it possible to determine a value of the first period T1 and a value of the second period T2. For all of the values of the first period T1 that are equal to a first reference value corresponding to the inverse of the first oscillating frequency or are within a first confidence interval with respect to the first reference value, for example fixed at 10% of the first reference value, the corresponding portion 142 of the raw digital signal 141 is associated with a first logic state 144, for example in this case equal to 1. In a comparable manner, for all of the values of the second period T2 that are equal to a second reference value corresponding to the inverse of the second oscillating frequency or are within a second confidence interval with respect to the second reference value, for example fixed at 10% of the second reference value, the corresponding portion 142 of the raw digital signal 141 is associated with a second logic state 144, for example in this case equal to 0.

It is thus possible to reconstruct a logic signal 143, for example a binary logic signal, from the raw digital signal 141. Such a logic signal 143 established during the binarization step 54 of the self-adaptive receiving process 50 according to the third aspect of the invention thus makes it possible to reconstruct the digital data frame which was carried by the modulated light beam.

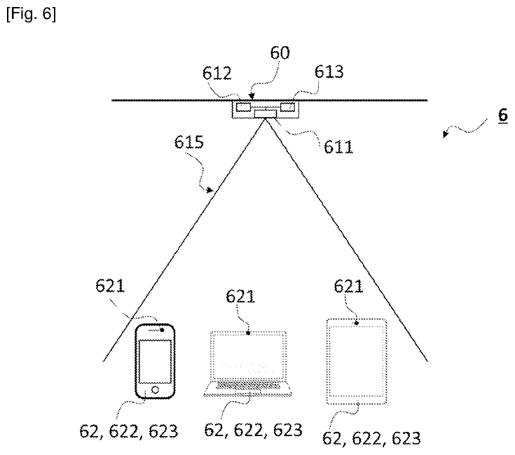

FIG. 6 is a schematic view of a system 6 for communication by means of light. A system 6 of this kind for communication by means of light comprises: (i) a light communication emitter system 61 designed to implement the light communication method 10 as described above with reference to FIGS. 1 to 3; and (ii) a light communication receiver system 62 designed to implement the self-adaptive receiving process as described with reference to FIGS. 4 and 5.

More particularly, the light communication emitter system 61 comprises:
at least one light source 611 designed to be able to generate a modulated light beam 615 which forms a signal for communication by means of light. By way of non-limiting example, the at least one light source 611 comprises one or more light-emitting sources;
a control module 612 designed to control the at least one light source 611 by generating a control signal from an encoded digital signal. By way of non-limiting example, the control module 612 comprises a digital-to-analog converter;
a processing unit 613 configured to be able to encode the digital signal to encode by means of digital calculations and/or digital processing and/or logic operations on digital data to be encoded. By way of non-limiting example, the processing unit 613 comprises one or more microprocessors.

The light communication receiver system 62 comprises:
a photodetector 621 designed to be able to detect a modulated light beam 615 which forms a signal for communication by means of light. By way of non-limiting example, the photodetector 621 is preferably a surface photodetector, such as a CMOS sensor or a CCD sensor;
an analog-to-digital converter 622 designed to convert the light communication signal detected by the photodetector 621 into a digital signal which represents the different levels of intensity of said light communication signal; and
a processing unit 623 designed to perform digital calculations and/or digital processing.

The photodetector 621 advantageously comprises a sliding shutter for “reading” a quantity of photons detected by each light-sensitive cell forming the photodetector 621. Indeed, the presence of a sliding shutter of this kind makes it possible to carry out a sequential reading of the different light-sensitive cells of the photodetector 621, each row of light-sensitive cells being “read” after another. Thus, the modulated light beam 615 incident on the photodetector 621 is detected by sliding the sliding shutter, thus causing the photons that are detected by a first line of the photodetector 621 to correspond to a first state of illumination of the light source 611 and therefore to a first light intensity, while causing the photons that are detected by a second line of the photodetector 621 and are directly adjacent to the first line to correspond to a second state of illumination of the light source 611 and therefore to a second light intensity. This particular acquisition process makes it possible to carry out a surface transcription, on the photodetector 621, of a temporal variation in the light intensity of the modulated light signal emitted by the light source.

Particularly advantageously in the context of the present invention, the light communication receiver system 62 is preferably of the kind found in a cell phone, a digital tablet or a portable computer, in order to utilize one of the cameras embedded on these devices. Indeed, it is an aim of the invention that it can be implemented by a light communication receiver system 62 of this kind in order to facilitate the deployment of applications using LiFi.

In summary, the invention relates in particular to a light communication method 10 implemented by a light communication emitter system 61, in which method a reference sequence 320 is shrewdly inserted periodically and repeatedly into a digital data frame to be transmitted by means of a modulated light beam 615. The presence of this reference sequence 320 allows a light communication receiver system 62 to automatically detect the reference sequence 320 in the detected modulated light beam 615. This detection makes it possible to automatically detect one of the two oscillating frequencies used to represent a logic state of the transmitted digital data, without having to calibrate the receiver system 62 on the basis of said oscillating frequencies.

Of course, the invention is not limited to the examples which have just been described and numerous modifications can be made to these examples without departing from the scope of the invention. In particular, the different features, forms, variants and embodiments of the invention may be combined with one another in various combinations, insofar as they are not incompatible or mutually exclusive. In particular, all of the variants and embodiments described above can be combined with one another.

1. Method for communicating digital data by means of light, the light communication method comprising the following steps:
a receiving step in which a processing unit of a light communication emitter system receives raw digital data;
an insertion step in which the processing unit of the light communication emitter system inserts a reference sequence at a constant interval, referred to as the self-adaptation interval, into the raw digital data, thus forming digital data to be encoded;
a step of encoding the digital data to be encoded according to an encoding protocol implemented by the processing unit of the light communication emitter system, thus forming an encoded digital signal, the encoded digital signal comprising a plurality of digital data divided into at least two different logic states;
a step of controlling a light source of the light communication emitter system using the encoded digital signal in order to generate a modulated light beam, the intensity of which is modulated by the encoded digital signal;
characterized in that the digital data to be encoded that is edited by the processing unit comprise a header section and a data section, a length of the self-adaptation interval being less than a length of the header section.

2. Light communication method according to clam 1, wherein the control step comprises a step of modulating:
a first logic state of the encoded digital signal according to a first oscillating frequency of the modulated light beam, and
a second logic state of the encoded digital signal according to a second oscillating frequency of the modulated light beam, the second oscillating frequency being different from the first oscillating frequency.

3. Light communication method according to claim 2, wherein a value of the second oscillating frequency is different from a value of the second oscillating frequency by at least 30%.

4. Light communication method according to claim 2, wherein a difference between a value of the second oscillating frequency and a value of the first oscillating frequency is between 5% and 15% of a bandwidth of a sliding shutter of a photodetector intended to detect the light beam.

5. Light communication method according to claim 1, wherein the reference sequence comprises exactly one reference bit in a given logic state.

6. Light communication method according to claim 1, wherein the length of the self-adaptation interval is equal to half the length of the header section.

7. Light communication method according to claim 6, wherein the header section having a length N+2 is formed of a sequence of N consecutive bits in a given first logic state, said sequence of N bits being framed at each end by a bit in a second logic state different from the first logic state, N being a natural number.

8. Light communication method according to claim 6, wherein the reference sequence is inserted into the data section whenever said data section comprises a sequence of X adjacent bits identical to a portion of X adjacent bits of the header section, the reference sequence being inserted at the end of said sequence of X adjacent bits of the data section.

9. Light communication emitter system comprising means for implementing the light communication method according to claim 1.

10. Light communication emitter system according to claim 9, wherein the means for implementing the light communication method comprise:
at least one light source designed to be able to generate a modulated light beam which forms a signal for communication by means of light;
a control module designed to control the at least one light source by generating a control signal from an encoded digital signal;
a processing unit designed to be able to encode the encoded digital signal by means of digital calculations and/or digital processing and/or logic operations on digital data to be encoded.
